(19) United States
(12) Patent Application Publication
(10) Pub. No.: US 2007/0273653 A1
(43) Pub. Date: Nov. 29, 2007

(54) METHOD AND APPARATUS FOR ESTIMATING RELATIVE MOTION BASED ON MAXIMUM LIKELIHOOD

(75) Inventors: HSIN CHIA CHEN, HSIN-CHU (TW); TZU YI CHAO, HSIN-CHU (TW)

Correspondence Address: LOWE HAUPTMAN HAM & BERNER, LLP, 1700 DIAGONAL ROAD, SUITE 300, ALEXANDRIA, VA, 22314, US

(73) Assignee: PIXART IMAGING INC., HSIN-CHU (TW)

(21) Appl. No.: 11/420,715

(22) Filed: May 26, 2006

(51) Int. Cl. G09G 5/08

(52) U.S. Cl. 345/166

(57) ABSTRACT

A method for estimating relative motion based on maximum likelihood and the apparatus using the same are provided. An image capture device captures a first image frame and a second image frame. An image buffer stores the image frames captured by the image capture device. A motion estimation device determines the motion of the second image frame relative to the first image frame. The motion estimation device calculates a probability density function of motion parameter candidates between the first and second image frames so as to determine the motion parameter where the probability density function is maximal as the motion of the second image frame relative to the first image frame.

### BACKGROUND OF THE INVENTION

1. Field of the Invention

The invention relates to methods and apparatus for estimating relative motion, and more particularly, to methods and apparatus for estimating relative motion based on maximum likelihood.

2. Description of the Related Art

An accurate determination of the path of movement for a device relative to a surface of interest is very important for diverse applications in many optical apparatuses and systems. For example, if a user intends to manipulate a cursor of a computer by moving an optical mouse over a surface, the movement of the cursor on a display screen in distance and direction is required to be proportional to the movement of the mouse. A typical optical mouse includes an array of sensors to capture images of the surface over which it moves at different times. The captured images are stored in a memory in digital format. The optical mouse further includes a processor for calculating a movement between two captured adjacent images. After the movement between the adjacent images is determined, a signal with the information about the movement is transmitted to the computer to cause a corresponding movement of the cursor on the computer screen.

One of conventional methods used to calculate the movement of the captured images is to detect pixel motions of the captured images and to determine the shift distance of the pixels. This conventional method takes a portion of a reference image frame captured at an earlier time as a search block and correlates the search block with a sample image frame captured at a later time to obtain a plurality of correlation values. The correlation values are then interpolated into a quadratic surface that has an absolute minimum. By determining the absolute minimum of the quadratic surface, the movement of the captured images can be obtained. The U.S. Pat. No. 5,729,008, entitled “METHOD AND DEVICE FOR TRACKING RELATIVE MOVEMENT BY CORRELATING SIGNALS FROM AN ARRAY OF PHOTOELEMENTS”, disclosed such technology.

With reference to FIG. 1, it illustrates a conventional method for determining relative movement of captured images. A reference frame 110 of 7-by-7 pixels is shown as having an image of a T-shaped inherent structural feature 112. At a later time (dt) the sensors of an optical navigation device acquire a sample frame 120 which is displaced with respect to the reference frame 110, but which shows substantially the same inherent structural feature 112. The duration dt is preferably set such that the relative displacement of the T-shaped feature 112 is less than one pixel. To detect the relative displacement of the sample image 120 with respect to the reference frame 110, an image frame 130 of 5-by-5 pixels that is selected from the reference frame 110 and includes the image of the T-shaped inherent structural feature 112 is chosen as a search block 130. The search block 130 is then used to compare with the sample frame 120. The search block 130 is allowed to move one pixel to the left, right, up and down. A member 150 represents sequential shifts of a pixel value of a particular pixel within the sample frame 120. The sequential shifts are individual offsets into the eight nearest-neighbor pixels. For example, step “0” means the search block 130 does not include a shift, step “1” shows the search block 130 has a leftward shift, step “2” shows a diagonal shift to the upward and to the left, step ‘3” shows an upward shift etc. Based on sequential shifts of the member 150, the search block 130 is correlated with the sample frame 120 as shown in position frames 140 to 148. As shown, the correlation result is a combination of the search block 130 and the sample frame 120. In this manner, the position frame 144 that indicates the step “4” has a minimum number of shaded pixels, which means the position frame 144 has highest correlation with the sample frame 120. With identifying the position frame of highest correlation, it is concluded that the sample frame 120 has a diagonal shift to the upward and to the right. Accordingly, the optical navigation device has moved downward and leftward in a time period of dt.

With reference to FIG. 2, the U.S. Pat. No. 6,859,199, entitled “METHOD AND APPARATUS FOR DETERMINING RELATIVE MOVEMENT IN AN OPTICAL MOUSE USING FEATURE EXTRACTION” disclosed a method for determining relative movement in an optical mouse by using a feature extraction. An image of 5-by-5 pixels is captured by the 5-by-5 sensor array of an optical mouse. The number in each grid box represents a magnitude of signal for the image captured by the corresponding sensor. As disclosed, various pixels have various signal strength. With reference to FIG. 3, a pixel gradient is calculated between each pixel and a certain of its neighboring pixels. The resulting pixel gradient map is the difference in signal strength between adjacent pixels in the left and right directions. Therefore, both positive and negative gradients can be shown, depending upon the difference between neighboring pixels. Next, features are extracted from the pixel gradient map. Features are defined as those pixel gradients that exceed a predetermined threshold. For example, if the predetermined threshold is a pixel gradient of fifty, then the pixel gradient map has three features 301. However, if the predetermined threshold is a pixel gradient of twenty, then the pixel gradient map has three additional features 303 in addition to the features 301. The predetermined threshold can be dynamic and will vary until a desired minimum number of features can be identified.

After the requisite number of features is determined, a feature set for a second subsequent image is determined. The second image will be related to the first image in some manner. With reference to FIG. 4, a pixel gradient map formed from a second subsequent image is shown. As can be seen, features 301 and 303 are also found, and they have been shifted one pixel to the right. This indicates that the second image, relative to the first image, has been shifted to the left, thereby indicating that the optical mouse has also been traversed to the left.

With reference to FIG. 5, another pixel map of an image formed on the sensor array is shown. The corresponding pixel gradient map is formed based upon the difference between adjacent pixels and is shown in FIG. 6. In another embodiment, features may be defined to be those pixel gradients that show an “inflexion point”. As seen in FIG. 6, five inflexion points 601 indicate a change in the trend of the pixel map of FIG. 5. The inflexion points 601 are those areas of the pixel map where the signal magnitude changes its trend.

However, all the two above-identified methods for determining relative movement of captured images start making a comparison between a first captured image and a subsequently captured image only after all pixel information in the subsequently captured image has been obtained. Rather, the comparison between the two captured images is not made until the whole second image has been captured.

With reference to FIG. 7, a conventional motion estimation apparatus 700 includes an image capture device 710 such as CMOS or CCD for capturing images. The captured images are stored in an image buffer 720. A motion estimation device 730 makes a comparison of the captured images stored in the image buffer 720 in order to determine the relative motion between the captured images. However, the motion estimation device 730 starts making a comparison between a first captured image and a subsequently captured image only after all pixel information in the subsequently captured image has been obtained if the above-identified methods for determining relative movement of captured images are adopted. The conventional methods are less efficient because the motion estimation devices 730 are idle before the second image is fully captured.

In view of the above, there exists a need to provide a method and apparatus for estimating relative motion that can overcome the above-identified problem encountered in the prior art. This invention addresses this need in the prior art as well as other needs, which will become apparent to those skilled in the art from this disclosure.

### SUMMARY OF THE INVENTION

It is an object of the present invention to provide a method for estimating relative motion based on maximum likelihood that can capture a new image frame and cumulatively calculate the probabilities of several motion parameter candidates simultaneously. The method of the present invention is much more efficient in determining the relative motion between the image frames.

In one embodiment, a method for estimating relative motion according to the present invention includes the steps of: capturing a first image frame and a second image frame; calculating a probability density function of motion parameter candidates between the first and second frames; and determining the motion parameter where the probability density function is maximal as the motion of the second image frame relative to the first image frame. The capturing the second image frame and calculating the probability of motion parameter candidates can be executed simultaneously.

It is another object of the present invention to provide a motion estimation apparatus for estimating relative motion based on maximum likelihood that can capture a new image frame and cumulatively calculate the probabilities of several motion parameter candidates simultaneously. The apparatus of the present invention is much more efficient in determining the relative motion between the image frames.

In one embodiment, the motion estimation apparatus for estimating relative motion according to the present invention includes an image capture device for capturing a first image frame and a second image frame. An image buffer stores the image frames captured by the image capture device. A motion estimation device determines the motion of the second image frame relative to the first image frame. The motion estimation device calculates a probability density function of motion parameter candidates between the first and second image frames so as to determine the motion parameter where the probability density function is maximal as the motion of the second image frame relative to the first image frame. The capturing the second image frame by the image capture device and calculating the probability of motion parameter candidates by the motion estimation device are executed simultaneously.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view illustrating a conventional method for determining relative movement of captured images.

FIG. 2 is a schematic view illustrating another conventional method for determining relative movement with a captured image being represented as varying light intensities on individual pixels of the sensor array.

FIG. 3 is a schematic view illustrating a feature extraction performed on the image of FIG. 2.

FIG. 4 is a schematic view illustrating a feature extraction performed on a subsequent image relative to the image of FIG. 2.

FIG. 5 is a schematic view illustrating another conventional method for determining relative movement with another captured image being represented as varying light intensities on individual pixels of the sensor array.

FIG. 6 is a schematic illustration of a feature extraction performed on the image of FIG. 5, showing an alternative class of features.

FIG. 7 is a schematic view illustrating a conventional motion estimation apparatus.

FIGS. 8a and 8b are schematic views illustrating a method for estimating relative motion according to the present invention, with two captured image frames comprised of a plurality of image pixels.

FIG. 9 is a flowchart illustrating the method for estimating relative motion based on maximum likelihood.

FIG. 10 is a schematic view illustrating a motion estimation apparatus based on maximum likelihood according to the present invention.

FIG. 11 is a schematic view illustrating an optical mouse based on maximum likelihood according to the present invention.

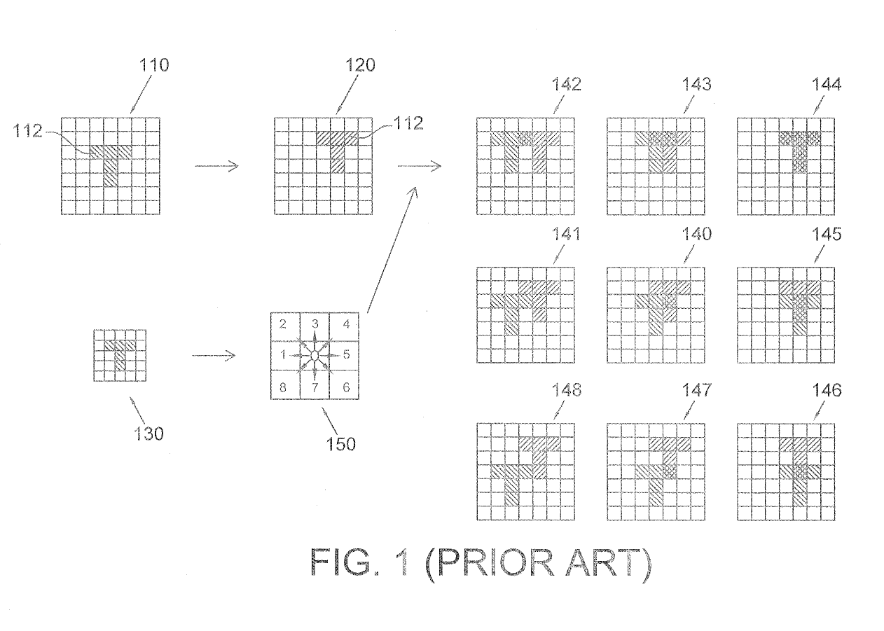

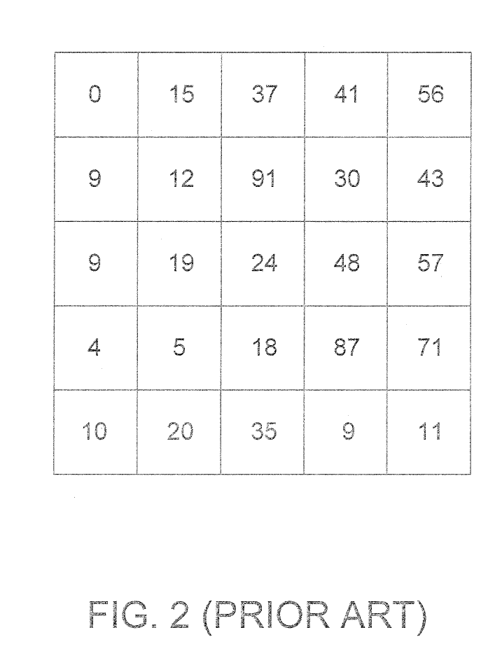

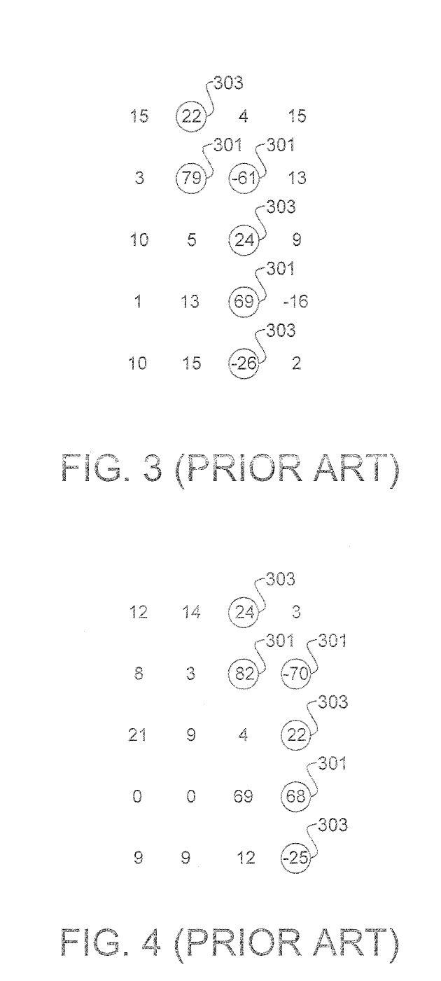

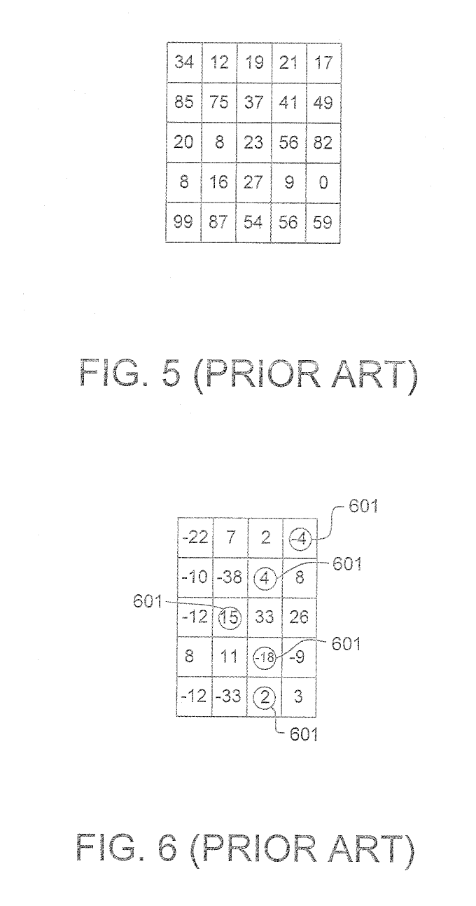

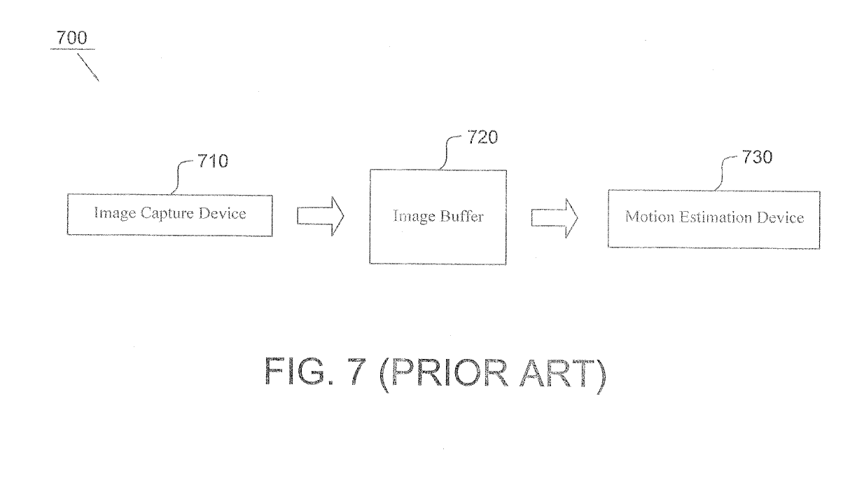

### DETAILED DESCRIPTION OF THE PREFERRED EMBODIMENT

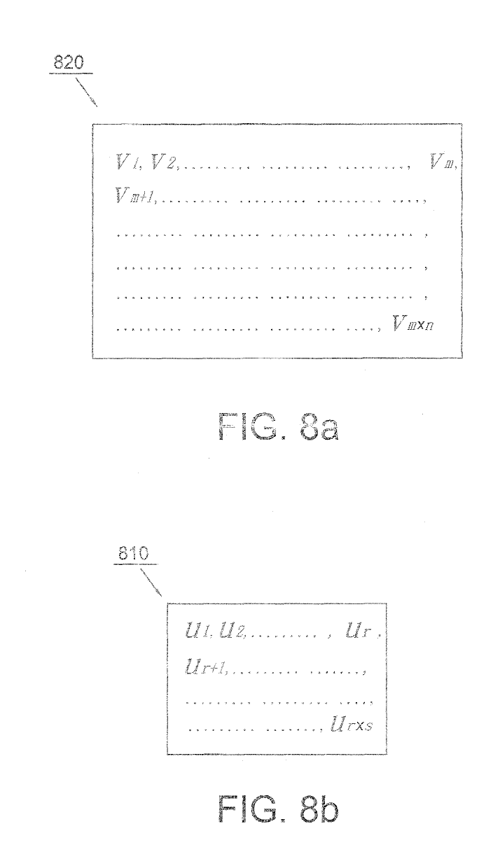

With reference to FIGS. 8a and 8b, a method for estimating relative motion according to an embodiment of the present invention is first to capture a reference frame 810 by the image capture device of an optical navigation device, such as CMOS or CCD. The reference frame 810 includes a plurality of image pixels u₁, u₂, . . . , uᵣ, uᵣ₊₁, . . . , u_{r×x}. Each pixel uᵢ, where i=1 to r×s, at leas t includes a coordinate information and an intensity information. Therefore, the pixel uᵢ can be expressed as uᵢ=uᵢ(Xᵢ^{u},Iᵢ^{u}), where Xᵢ^{u} is the coordinate of the pixel i of the reference frame 810 and Iᵢ^{u} is the intensity of pixel i. However, other features, such as gradient in formation, extracted in local area can also be included in uᵢ. After a period of time since the reference frame 810 was captured, a new frame 820 including a plurality of image pixels vⱼ, v₂, . . . , vₘ, vₘ₊₁, . . . , v_{m×n} is captured. Similarly, the pixel vⱼ, where j=1 to m×n, can also be expressed as vⱼ=vⱼ(Xⱼ^{v},Iⱼ^{v}), where Xⱼ^{v} is the coordinate of the pixel j of the new frame 820 and Iⱼ^{v} is the intensity of pixel j.

To estimate the relative motion between the frames 810 and 820, a probability density function of motion parameter Φ is to be estimated. The probability density function of the motion parameter Φ is defined as conditional probability function p(Φ | u₁, u₂, . . . , u_{M}, v₁, v₂, . . . , v_{N}), where M≡r×s, N≡m×n. A conditional probability P(A|B) is the probability of some event A, given the occurrence of some other event B. It is to be noted that M can be the pixel number in the reference frame 810, and N can be the pixel number in the new frame 820. Therefore, each of both M and N can be some specified number.

According to Bayes' theorem in probability theory, the conditional probability p(Φ | u₁, u₂, . . . , u_{M}, v₁, v₂, . . . , v_{N}) can be expanded as

$$p ( Φ \vert {u}_{1} , {u}_{2} , … , {u}_{r \times s} , {v}_{1} , {v}_{2} , … , {v}_{m \times n} ) = \frac{\begin{matrix}p ( {v}_{1} , {v}_{2} , … , {v}_{m \times n} \vert {u}_{1} , {u}_{2} , … , {u}_{r \times s} , Φ ) \\ p ( Φ \vert {u}_{1} , {u}_{2} , … , {u}_{r \times s} )\end{matrix}}{p ( {v}_{1} , {v}_{2} , … , {v}_{m \times n} \vert {u}_{1} , {u}_{2} , … , {u}_{r \times s} )} \qquad ( 1 )$$

To find the motion parameter Φ where the function p(Φ | u₁,u₂, . . . ,u_{r×s},v₁,v₂, . . . ,v_{m×x}) is maximal, one can find the motion parameter Φ where the function p(v₁,v₂, . . . ,v_{m×n} | u₁,u₂, . . . ,u_{r×s},Φ) is maximal. It is assumed that the probability distribution of motion parameter, Φ, to be estimated is uniform, and therefore the negative log-likelihood function L can be written as

$${max}_{Φ} \{ L ( {v}_{1} , {v}_{2} , … , {v}_{m \times n} \vert {u}_{1} , {u}_{2} , … , {u}_{r \times s} , Φ ) \} = {min}_{Φ} \{ - log [ p ( {v}_{1} , {v}_{2} , … , {v}_{m \times n} \vert {u}_{1} , {u}_{2} , … , {u}_{r \times s} , Φ ) ] \} \qquad ( 2 )$$

Equation 2 denotes that finding the maximum of function L(v₁,v₂, . . . ,v_{m×n}|u₁,u₂, . . . ,u_{r×s},Φ) is equivalent to finding the minimum of function −log[p(v₁,v₂, . . . ,v_{m×n}|u₁,u₂, . . . ,u_{r×s},Φ)]. In general circumstances, m×n observations are independently and identically distributed. Therefore, under the assumption of independent and identical distribution of the m×n observations, the function −log[p(v₁,v₂, . . . ,v_{m×n}|u₁,u₂, . . . ,u_{r×s},Φ)] can be transformed to

$$- log [ {\prod }_{j = 1}^{m \times n} p ( {v}_{j} \vert {u}_{1} , {u}_{2} , … , {u}_{r \times s} , Φ ) ] .$$

### Because logarithm of product is equivalent to sum of logarithms, the function −log[p(v₁,v₂, . . . ,v_{m×n}|u₁,u₂, . . . ,u_{r×s},Φ)] is further transformed to

$$- {\sum }_{j = 1}^{m \times n} log [ p ( {v}_{j} \vert {u}_{1} , {u}_{2} , … , {u}_{r \times s} , Φ ) ] . \\ Therefore , {max}_{Φ} \{ L ( {v}_{1} , {v}_{2} , … , {v}_{m \times n} \vert {u}_{1} , {u}_{2} , … , {u}_{r \times s} , Φ ) \} = {min}_{Φ} \{ - {\sum }_{j = 1}^{m \times n} log [ p ( {v}_{j} \vert {u}_{1} , {u}_{2} , … , {u}_{r \times s} , Φ ) ] \} \qquad ( 3 )$$

The following will illustrate how to exploit Equation 3 to estimate the relative motion between the frames 810 and 820.

If the motion of the new frame 820 relative to the reference frame 810 is a pure translation, the motion parameter Φ can be reduced to a displacement vector X. Accordingly,

$${max}_{Φ} \{ L ( {v}_{1} , {v}_{2} , … , {v}_{m \times n} \vert {u}_{1} , {u}_{2} , … , {u}_{r \times s} , Φ ) \} = {min}_{X} \{ - {\sum }_{j = 1}^{m \times n} log [ p ( {v}_{j} \vert {u}_{1} , {u}_{2} , … , {u}_{r \times s} , X ) ] \} \qquad ( 4 )$$

It is assumed that the magnitude of probability function is proportional to exponential of the absolute value of the intensity difference between pixels in the two frames 810 and 820, and therefore the function p(vⱼ|u₁,u₂, . . . ,u_{r×S},X) can be modeled as follows:

$$p ( {v}_{j} \vert {u}_{1} , {u}_{2} , … , {u}_{r \times s} , X ) = {\prod }_{i = 1}^{r \times s} [ exp ( - \vert {I}_{j}^{v} - {I}_{i}^{u} \vert ) \cdot f ( {v}_{j} , {u}_{i} , X ) ] \qquad ( 5 )$$

Accordingly, the

$${max}_{Φ} \{ L ( {v}_{1} , {v}_{2} , … , {v}_{m \times n} \vert {u}_{1} , {u}_{2} , … , {u}_{r \times s} , Φ ) \}$$

can be expressed as:

$${max}_{Φ} \{ L ( {v}_{1} , {v}_{2} , … , {v}_{m \times n} \vert {u}_{1} , {u}_{2} , … , {u}_{r \times s} , Φ ) \} = {min}_{X} \{ - {\sum }_{j = 1}^{m \times n} log \{ {\prod }_{i = 1}^{r \times s} [ exp ( - \vert {I}_{j}^{v} - {I}_{i}^{u} \vert ) \cdot f ( {v}_{j} , {u}_{i} , X ) ] \} \} \qquad ( 6 )$$

With the use of that logarithm of product is equivalent to sum of logarithms, Equation 6 can be converted to:

$${max}_{Φ} \{ L ( {v}_{1} , {v}_{2} , … , {v}_{m \times n} \vert {u}_{1} , {u}_{2} , … , {u}_{r \times s} , Φ ) \} = {min}_{X} \{ - {\sum }_{j = 1}^{m \times n} {\sum }_{i = 1}^{r \times s} log [ exp ( - \vert {I}_{j}^{v} - {I}_{i}^{u} \vert ) \cdot f ( {v}_{j} , {u}_{i} , X ) ] \} \qquad ( 7 )$$

When the distance between the pixel j of the new frame 820 and the pixel i of the reference frame 810 is larger than a specified threshold value, the importance of the absolute value of the intensity difference between the pixels j and i to the function ƒ(vⱼ,uᵢ,X) is negligible. Accordingly, the function ƒ(vⱼ,uᵢ,X) can be modeled as:

$$f ( {v}_{j} , {u}_{i} , X ) = \{ \begin{matrix}exp \vert {I}_{j}^{v} - {I}_{i}^{u} \vert , & if ‖ ( {X}_{j}^{v} - {X}_{i}^{u} ) - X ‖ - TH > 0 \\ 1 , & if ‖ ( {X}_{j}^{v} - {X}_{i}^{u} ) - X ‖ - TH \leq 0\end{matrix} \qquad ( 8 )$$

where TH is the specified threshold value, and ∥(Xⱼ^{v}−Xᵢ^{u})−X∥ is the norm of (Xⱼ^{v}−Xᵢ^{u}−X).

If the motion of the new frame 820 relative to the reference frame 810 is a pure rotation, the motion parameter Φ can be reduced to an angular parameter θ. Accordingly,

$${max}_{Φ} \{ L ( {v}_{1} , {v}_{2} , … , {v}_{m \times n} \vert {u}_{1} , {u}_{2} , … , {u}_{r \times s} , Φ ) \} = {min}_{θ} \{ - {\sum }_{j = 1}^{m \times n} log [ p ( {v}_{j} \vert {u}_{1} , {u}_{2} , … , {u}_{r \times s} , θ ) ] \} \qquad ( 9 )$$

Similarly, Equation 9 can be converted to:

$${max}_{Φ} \{ L ( {v}_{1} , {v}_{2} , … , {v}_{m \times n} \vert {u}_{1} , {u}_{2} , … , {u}_{r \times s} , Φ ) \} = {min}_{θ} \{ - {\sum }_{j = 1}^{m \times n} {\sum }_{i = 1}^{r \times s} log [ exp ( - \vert {I}_{j}^{v} - {I}_{i}^{u} \vert ) \cdot f ( {v}_{j} , {u}_{i} , θ ) ] \} \qquad ( 10 )$$

When the angle between the pixel j of the new frame 820 and the pixel i of the reference frame 810 is larger than a specified threshold value, the importance of the absolute value of the intensity difference between the pixels j and i to the function ƒ(vⱼ,uᵢ,θ) is negligible. Accordingly, the function ƒ(vⱼ,uᵢ,θ) can be modeled as:

$$f ( {v}_{j} , {u}_{i} , θ ) = \{ \begin{matrix}exp \vert {I}_{j}^{v} - {I}_{i}^{u} \vert , & if ‖ {X}_{j}^{v} - A ( θ ) {X}_{i}^{u} ‖ - TH > 0 \\ 1 , & if ‖ {X}_{j}^{v} - A ( θ ) {X}_{i}^{u} ‖ - TH \leq 0\end{matrix} \qquad ( 11 )$$

where TH is the specified threshold value, A is the angular operator, A(θ) can be such as an angular transformation matrix of rotation angle θ.

If the motion of the new frame 820 relative to the reference frame 810 is a translation plus rotation, the motion parameters Φ can be expressed as Φ=Φ(θ,X). Accordingly,

$${max}_{Φ} \{ L ( {v}_{1} , {v}_{2} , … , {v}_{m \times n} \vert {u}_{1} , {u}_{2} , … , {u}_{r \times s} , Φ ) \} = {min}_{( θ , X )} \{ - {\sum }_{j = 1}^{m \times n} log [ p ( {v}_{j} \vert {u}_{1} , {u}_{2} , … , {u}_{r \times s} , θ , X ) ] \} \qquad ( 12 )$$

Similarly, Equation 12 can also be converted and simplified to:

$${max}_{Φ} \{ L ( {v}_{1} , {v}_{2} , … , {v}_{m \times n} \vert {u}_{1} , {u}_{2} , … , {u}_{r \times s} , Φ ) \} = {min}_{( θ , X )} \{ {\sum }_{j = 1}^{m \times n} {\sum }_{i = 1}^{r \times s} [ \vert {I}_{j}^{v} - {I}_{i}^{u} \vert - log ( f ( {v}_{j} , {u}_{i} , θ , X ) ) ] \} \qquad ( 13 )$$

The function can also be similarly modeled as:

$$f ( {v}_{j} , {u}_{i} , θ , X ) = \{ \begin{matrix}exp \vert {I}_{j}^{v} - {I}_{i}^{u} \vert , & if ‖ {X}_{j}^{v} - A ( θ ) {X}_{i}^{u} - X ‖ - TH > 0 \\ 1 , & if ‖ {X}_{j}^{v} - A ( θ ) {X}_{i}^{u} - X ‖ - TH \leq 0\end{matrix} \qquad ( 14 )$$

where TH is the specified threshold value, A is the angular operator, A(θ) can be such as an angular transformation matrix of rotation angle θ.

From Equations 1 to 3, one can estimate the relative motion between the reference frame 810 and new frame 820 by finding the Φ where the function

$$- {\sum }_{j = 1}^{m \times n} log [ p ( {v}_{j} \vert {u}_{1} , {u}_{2} , … , {u}_{r \times s} , Φ ) ]$$

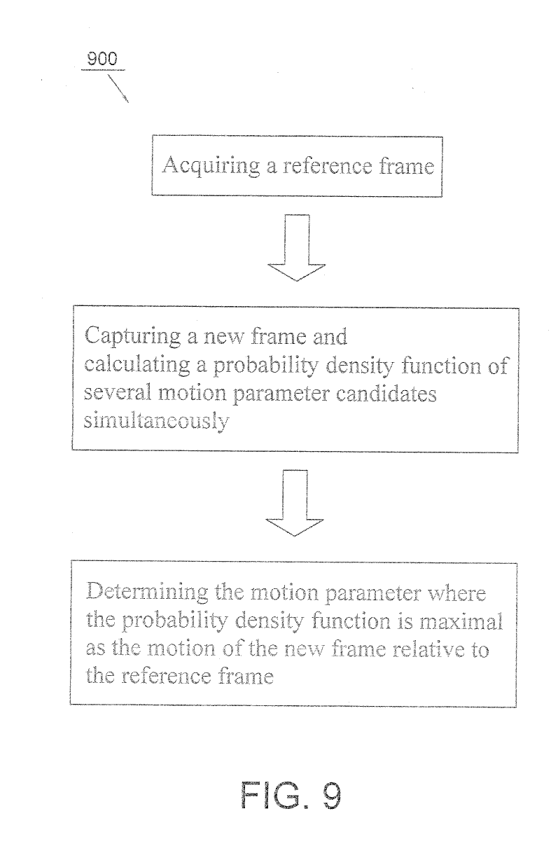

is minimal. Unlike the conventional method that starts making a calculation between the frames only after all pixel information in each image has been obtained, the method of the present invention can capture a new frame and cumulatively calculate the probabilities of several motion parameter candidates simultaneously. The motion parameter Φ where the probability density function p(Φ | u₁, u₂, . . . , u_{M}, v₁, v₂, . . . , v_{N}) is maximal is determined as the motion of the new frame 820 relative to the reference frame 810. The method of the present invention is much more efficient in determining the relative motion between the frames because it makes a calculation based on a pixel-by-pixel basis between the frames, and therefore can make cumulative calculations before the new frame is fully captured. FIG. 9 illustrates the method 900 for estimating relative motion based on maximum likelihood.

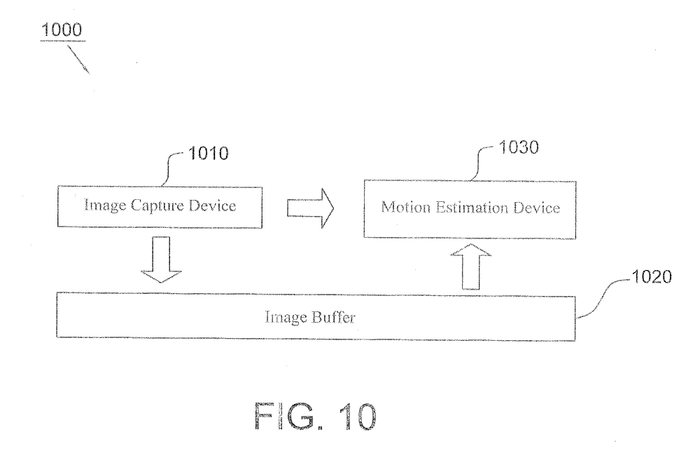

With reference to FIG. 10, a motion estimation apparatus 1000 based on maximum likelihood according to the present invention includes an image capture device 1010 such as CMOS or CCD for capturing image frames. The captured image frames are stored in an image buffer 1020 on a pixel-by-pixel basis. A motion estimation device 1030 makes a pixel-by-pixel calculation between a first image frame captured at an earlier time and stored in the image buffer 1020 and a second image frame captured at a later time and directly coming from the image capture device 1010 or stored in the image buffer 1020 to determine the motion of the second image frame relative to the first image frame. The motion estimation apparatus 1000 uses the above-identified method 900 to estimate the relative motion between the first and second image frames. The capture of the second image frame by the image capture device 1010 and the cumulative calculation of the probabilities of several motion parameter candidates by the motion estimation device 1030 can be executed simultaneously. The motion parameter Φ where the probability density function p(Φ | u₁, u₂, . . . , u_{M}, v₁, v₂, . . . , v_{N}) is maximal is determined as the motion of the second image frame relative to the first image frame. The motion estimation apparatus 1000 of the present invention is much more efficient in determining the relative motion between the image frames than the conventional motion estimation apparatus 700.

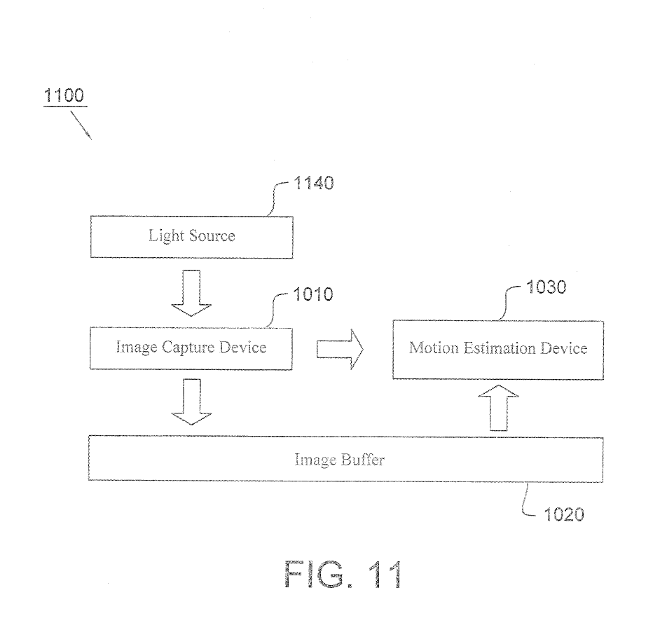

The motion estimation apparatus 1000 based on maximum likelihood according to the present invention can be used in an optical mouse or a motion tracker. With reference to FIG. 11, an optical mouse 1100 of the present invention includes a light source 1140 for emitting a light beam. The light beam is reflected off a surface over which the mouse 1100 moving and reaches the image capture device 1010 of the motion estimation apparatus 1000 as an image frame. The captured image frames by the image capture device 1010 are then stored in the image buffer 1020 on a pixel-by-pixel basis. The motion estimation device 1030 makes a pixel-by-pixel calculation between a first image frame captured at an earlier time and stored in the image buffer 1020 and a second image frame captured at a later time and coming from the image capture device 1010. The motion estimation apparatus 1000 can use the above-identified method 900 to determine the relative displacement between the first and second image frames. The capture of the second image frame by the image capture device 1010 and cumulative calculation of the probability of motion displacement by the motion estimation device 1030 can be executed simultaneously. The maximal probability for the motion displacement is determined by the motion estimation device 1030. The motion of the optical mouse 1100 is equivalent to the motion between the image frames captured at two different times. A signal with the information about the motion of mouse 1100 is transmitted to a computer to cause a corresponding movement of the cursor on the computer screen.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A method for estimating relative motion, comprising:
capturing a first image frame comprised of a plurality of image pixels;
capturing a second image frame comprised of a plurality of image pixels;
calculating a probability density function of motion parameter candidates between the first image frame and second image frame; and
determining the motion parameter where the probability density function is maximal as the motion of the second image frame relative to the first image frame.

2. The method as claimed in claim 1, wherein the calculation between the first and second image frames is based on a pixel-by-pixel basis.

3. The method as claimed in claim 1, wherein capturing the second image frame and calculating the probability density function of motion parameter candidates are executed simultaneously.

4. The method as claimed in claim 1, wherein the probability density function is a conditional probability function p(Φ | u₁, u₂, . . . , u_{M}, v₁, v₂, . . . , v_{N}), where the M is the pixel number in the first image frame, the N is the pixel number in the second image frame, the u₁, u₂, . . . , u_{M} are image pixels in the first image frame, the v₁, v₂, . . . , v_{N} are image pixels in the second image frame, and the Φ is the motion parameter.

5. The method as claimed in claim 4, wherein determining the motion parameter where the function p(Φ | u₁, u₂, . . . , u_{M}, v₁, v₂, . . . , v_{N}) is maximal is equivalent to determining the motion parameter where the function p(v₁,v₂, . . . ,v_{N} | u₁,u₂, . . . ,u_{M},Φ) is maximal.

6. The method as claimed in claim 5, wherein the probability distribution of the motion parameters is uniform.

7. The method as claimed in claim 5, wherein determining the motion parameter where the function p(v₁,v₂, . . . ,v_{N} | u₁,u₂, . . . ,u_{M},Φ) is maximal is equivalent to determining the motion parameter where the function −log[p(v₁,v₂, . . . ,v_{N} | u₁,u₂, . . . ,u_{M},Φ)] is minimal.

8. The method as claimed in claim 5, wherein N observations are independently and identically distributed.

9. The method as claimed in claim 5, wherein determining the motion parameter where the function p(v₁,v₂, . . . ,v_{N} | u₁,u₂, . . . ,u_{M},Φ) is maximal is equivalent to determining the motion parameter where the function
$$- {\sum }_{j = 1}^{N} log [ p ( {v}_{j} \vert {u}_{1} , {u}_{2} , … , {u}_{M} , Φ ) ]$$
is minimal,
where the vⱼ is the pixel j in the second image frame.

10. The method as claimed in claim 9, wherein the motion parameter Φ is a displacement vector X, the function log[p(vⱼ|u₁,u₂, . . . ,u_{M},Φ)] is represented as
$${\sum }_{i = 1}^{M} log [ exp ( - \vert {I}_{j}^{v} - {I}_{i}^{u} \vert ) \cdot f ( {v}_{j} , {u}_{i} , X ) ] ,$$
wherein the function ƒ(vⱼ,uᵢ,X) is modeled as:
$$f ( {v}_{j} , {u}_{i} , X ) = \{ \begin{matrix}exp \vert {I}_{j}^{v} - {I}_{i}^{u} \vert , & ‖ ( {X}_{j}^{v} - {X}_{i}^{u} ) - X ‖ - TH > 0 \\ 1 , & ‖ ( {X}_{j}^{v} - {X}_{i}^{u} ) - X ‖ - TH \leq 0\end{matrix}$$
where Iᵢ^{u} is the intensity of the pixel i of the first image frame, Iⱼ^{v} is the intensity of the pixel j of the second image frame, Xᵢ^{u} is the coordinate of the pixel i of the first image frame, Xⱼ^{v} is the coordinate of the pixel j of the second image frame, the TH is the threshold value, and ∥(Xⱼ^{v}−Xᵢ^{u})−X∥ is the norm of (Xⱼ^{v}−Xᵢ^{u}−X).

11. The method as claimed in claim 9, wherein the motion parameter Φ is an angular parameter θ, the function log[p(vⱼ|u₁,u₂, . . . ,u_{M},θ)] is represented as
$${\sum }_{i = 1}^{M} log [ exp ( - \vert {I}_{j}^{v} - {I}_{i}^{u} \vert ) \cdot f ( {v}_{j} , {u}_{i} , θ ) ] ,$$
wherein the function ƒ(vⱼ,uᵢ,θ) is modeled as:
$$f ( {v}_{j} , {u}_{i} , θ ) = \{ \begin{matrix}exp \vert {I}_{j}^{v} - {I}_{i}^{u} \vert , & ‖ {X}_{j}^{v} - A ( θ ) {X}_{i}^{u} ‖ - TH > 0 \\ 1 , & ‖ {X}_{j}^{v} - A ( θ ) {X}_{i}^{u} ‖ - TH \leq 0\end{matrix}$$
where Iᵢ^{u} is the intensity of the pixel i of the first image frame, Iⱼ^{v} is the intensity of pixel j of the second image frame, Xᵢ^{u} is the coordinate of the pixel i of the first image frame, Xⱼ^{v} is the coordinate of pixel j of the second image frame, the TH is the threshold value, and A(θ) is the angular transformation matrix.

12. The method as claimed in claim 9, wherein the motion parameter Φ is a translation plus rotation, the motion parameter Φ is expressed as Φ=Φ(θ,X), the function log[p(vⱼ|u₁,u₂, . . . ,u_{M},Φ)] is represented as
$${\sum }_{i = 1}^{M} log [ exp ( - \vert {I}_{j}^{v} - {I}_{i}^{u} \vert ) \cdot f ( {v}_{j} , {u}_{i} , θ , X ) ] ,$$
wherein the function ƒ(vⱼ,uᵢ,θ,X) is modeled as:
$$f ( {v}_{j} , {u}_{i} , θ , X ) = \{ \begin{matrix}exp \vert {I}_{j}^{v} - {I}_{i}^{u} \vert , & ‖ {X}_{j}^{v} - A ( θ ) {X}_{i}^{u} - X ‖ - TH > 0 \\ 1 , & ‖ {X}_{j}^{v} - A ( θ ) {X}_{i}^{u} - X ‖ - TH \leq 0\end{matrix}$$
where Iᵢ^{u} is the intensity of pixel i of the first image frame, Iⱼ^{v} is the intensity of pixel j of the second image frame, Xᵢ^{u} is the coordinate of pixel i of the first image frame, Xⱼ^{v} is the coordinate of pixel j of the second image frame, the TH is the threshold value, the A(θ) is the angular transformation matrix.

13. A motion estimation apparatus for estimating relative motion, comprising:
an image capture device for capturing a first image frame and a second image frame, the first image frame comprised of a plurality of image pixels and the second image frame comprised of a plurality of image pixels;
an image buffer for storing image frames; and
a motion estimation device for determining the motion of the second image frame relative to the first image frame,
wherein the motion estimation device calculates a probability density function of motion parameter candidates between the first and second image frames so as to determine the motion parameter where the probability density function is maximal as the motion of the second image frame relative to the first image frame.

14. The motion estimation apparatus as claimed in claim 13, wherein capturing the second image frame by the image capture device and calculating the probability of motion parameter candidates by the image capture device are executed simultaneously.

15. The motion estimation apparatus as claimed in claim 13, wherein the probability density function is a conditional probability function p(Φ | u₁, u₂, . . . , u_{M}, v₁, v₂, . . . , v_{N}), where the M is the pixel number in the first image frame, the N is the pixel number in the second image frame, the u₁, u₂, . . . , u_{M} are image pixels in the first image frame, the v₁, v₂, . . . , v_{N} are image pixels in the second image frame, and the Φ is the motion parameter.

16. The motion estimation apparatus as claimed in claim 15, wherein determining the motion parameter where the function p(Φ | u₁, u₂, . . . , u_{M}, v₁, v₂, . . . , v_{N}) is maximal is equivalent to determining the motion parameter where the function p(v₁, v₂, . . . , v_{N} | u₁, u₂, . . . , u_{M},Φ) is maximal.

17. The motion estimation apparatus as claimed in claim 16, wherein the probability distribution of the motion parameters is uniform.

18. The motion estimation apparatus as claimed in claim 16, wherein determining the motion parameter where the function p(v₁,v₂, . . . ,v_{N} | u₁,u₂, . . . ,u_{M},Φ) is maximal is equivalent to determining the motion parameter where the function −log[p(v₁,v₂, . . . ,v_{N} | u₁,u₂, . . . ,u_{M},Φ)] is minimal.

19. The motion estimation apparatus as claimed in claim 16, wherein N observations are independently and identically distributed.

20. The motion estimation apparatus as claimed in claim 16, wherein determining the motion parameter where the function p(v₁,v₂, . . . ,v_{N} | u₁,u₂, . . . ,u_{M},Φ) is maximal is equivalent to determining the motion parameter where the function
$$- {\sum }_{j = 1}^{N} log [ p ( {v}_{j} \vert {u}_{1} , {u}_{2} , … , {u}_{M} , Φ ) ]$$
is minimal,
where the vⱼ is the pixel j in the second image frame.

21. The motion estimation apparatus as claimed in claim 20, wherein the motion parameter Φ is a displacement vector X, the function log[p(vⱼ|u₁,u₂, . . . ,u_{M},Φ)] is represented as
$${\sum }_{i = 1}^{M} log [ exp ( - \vert {I}_{j}^{v} - {I}_{i}^{u} \vert ) \cdot f ( {v}_{j} , {u}_{i} , X ) ] ,$$
wherein the function ƒ(vⱼ,uᵢ,X) is modeled as:
$$f ( {v}_{j} , {u}_{i} , X ) = \{ \begin{matrix}exp \vert {I}_{j}^{v} - {I}_{i}^{u} \vert , & ‖ ( {X}_{j}^{v} - {X}_{i}^{u} ) - X ‖ - TH > 0 \\ 1 , & ‖ ( {X}_{j}^{v} - {X}_{i}^{u} ) - X ‖ - TH \leq 0\end{matrix}$$
where Iᵢ^{u} is the intensity of pixel i of the first image frame, Iⱼ^{v} is the intensity of pixel j of the second image frame, Xᵢ^{u} is the coordinate of pixel i of the first image frame, Xⱼ^{v} is the coordinate of pixel j of the second image frame, the TH is the threshold value, and ∥(Xⱼ^{v}−Xᵢ^{u})−X∥ is the norm of (Xⱼ^{v}−Xᵢ^{u}−X).

22. The motion estimation apparatus as claimed in claim 20, wherein the motion parameter Φ is an angular parameter θ, the function log[p(vⱼ|u₁,u₂, . . . ,u_{M},Φ)] is represented as
$${\sum }_{i = 1}^{M} log [ exp ( - \vert {I}_{j}^{v} - {I}_{i}^{u} \vert ) \cdot f ( {v}_{j} , {u}_{i} , θ ) ] ,$$
wherein the function ƒ(vⱼ,uᵢ,θ) is modeled as:
$$f ( {v}_{j} , {u}_{i} , θ ) = \{ \begin{matrix}exp \vert {I}_{j}^{v} - {I}_{i}^{u} \vert , & ‖ {X}_{j}^{v} - A ( θ ) {X}_{i}^{u} ‖ - TH > 0 \\ 1 , & ‖ {X}_{j}^{v} - A ( θ ) {X}_{i}^{u} ‖ - TH \leq 0\end{matrix}$$
where Iᵢ^{u} is the intensity of pixel i of the first image frame, Iⱼ^{v} is the intensity of pixel j of the second image frame, Xᵢ^{u} is the coordinate of pixel i of the first image frame, Xⱼ^{v} is the coordinate of pixel j of the second image frame, the TH is the threshold value, and A(θ) is the angular transformation matrix.

23. The motion estimation apparatus as claimed in claim 20, wherein the motion parameter Φ is a translation plus rotation, the motion parameter Φ is expressed as Φ=Φ(θ,X), the function log[p(vⱼ|u₁,u₂, . . . ,u_{M},Φ)] is represented as
$${\sum }_{i = 1}^{M} log [ exp ( - \vert {I}_{j}^{v} - {I}_{i}^{u} \vert ) \cdot f ( {v}_{j} , {u}_{i} , θ , X ) ] ,$$
wherein the function ƒ(vⱼ,uᵢ,θ,X) is modeled as:
$$f ( {v}_{j} , {u}_{i} , θ , X ) = \{ \begin{matrix}exp \vert {I}_{j}^{v} - {I}_{i}^{u} \vert , & ‖ {X}_{j}^{v} - A ( θ ) {X}_{i}^{u} - X ‖ - TH > 0 \\ 1 , & ‖ {X}_{j}^{v} - A ( θ ) {X}_{i}^{u} - X ‖ - TH \leq 0\end{matrix}$$
where Iᵢ^{u} is the intensity of pixel i of the first image frame, Iⱼ^{v} is the intensity of pixel j of the second image frame, Xᵢ^{u} is the coordinate of pixel i of the first image frame, Xⱼ^{v} is the coordinate of pixel j of the second image frame, the TH is the threshold value, and A(θ) is the angular transformation matrix.

24. An optical mouse, comprising:
an image capture device for capturing a first image frame and a second image frame, the first image frame comprised of a plurality of image pixels and the second image frame comprised of a plurality of image pixels;
a light source for emitting a light beam, the light beam reflected off the surface over which the optical mouse moving and reaching the image capture device as an image frame;
an image buffer for storing a plurality of image frames; and
a motion estimation device for determining the motion of the optical mouse,
wherein the motion estimation device calculates a probability density function of displacement vector between the first and second image frames so as to determine the displacement vector where the probability density function is maximal as the motion displacement of the optical mouse.

25. The optical mouse as claimed in claim 24, wherein capturing the second image frame by the image capture device and calculating the probability of displacement vector by the image capture device are executed simultaneously.
